(19) United States
(12) Patent Application Publication
(10) Pub. No.: US 2013/0298838 A1
(43) Pub. Date: Nov. 14, 2013

(54) Portable Pet Hydration System

(71) Applicants: Cesar Belmonte, (US); Eduardo Talbert, (US)

(72) Inventors: Cesar Belmonte, (US); Eduardo Talbert, (US)

(21) Appl. No.: 13/471,045

(22) Filed: May 14, 2012

(51) Int. Cl. A01K 7/00; A01K 29/00; F16B 45/02

(52) U.S. Cl. 119/72; 24/598.2

(57) ABSTRACT

A portable pet hydration system which may be attached to a pet's leash or to the user's clothing, which is used to quickly and easily supply liquid, such as water, to companion animals while away from home or engaged in activities outdoors. Various embodiments are described.

### BACKGROUND OF THE INVENTION

Providing adequate hydration to companion animals when away from home is an important concern for many pet owners. There may be few publicly available clean water sources out of doors, especially in urban areas, and those that may exist, such as water fountains designed for human use, are not readily usable by dogs or other animals. Pet owners who take their dogs on extended walks or hikes, or accompany their companion animals for active play in the out of doors without bringing along a good supply of fresh water, may risk exposing their pet to dehydration, hyperthermia (overheating), or waterborne illness.

Dogs are especially prone to overheat in warm weather because they can't sweat through most of their skin like humans do, and their fur also traps heat. Instead, dogs cool themselves by panting, the excess heat being carried away by water evaporating from their airway and mouth. Short-nosed dogs are most prone to overheat, because their shorter airways are less effective at cooling. The water lost to evaporation needs then to be replaced, and even in cooler months, active dogs need water to replenish losses due to the low humidity.

Various hydration devices for dogs or other companion animals have been proposed, including a variety of water bottles having attached bowls, and hydration collars and backpacks wearable by dogs. Water bottles lack storage for other supplies such as treats, keys, and waste bags required by many localities. Usually clipped to a belt, these bottles must be unclipped and unfolded to provide water to the animal. Hydration collars and backpacks may pose difficulty for small dogs which can't carry as much, so transporting water on the dog may not be a practical option for smaller breeds. There therefore exists a need for a convenient means for carrying and providing water for dogs that combines storage and hydration functions, and is suitable for use with both large and small breeds.

### BRIEF DESCRIPTION OF THE DRAWINGS

FIG. 1 is a left side front perspective view of a pet hydration system according to an embodiment of the invention, depicting the exterior of the case with the dispensing hose in a coiled position.

FIG. 2 is a left side rear perspective view of a pet hydration system according to an embodiment of the invention, depicting the exterior of the case with the dispensing hose in a coiled position.

FIG. 3 is a right side top perspective view of a pet hydration system according to an embodiment of the invention, depicting the belt loops on the exterior right side of the case and showing the dispensing hose in a coiled position.

FIG. 4 is a left side perspective view of a pet hydration system according to an embodiment of the invention, depicting the exterior of the reservoir with the dispensing hose in a coiled position.

FIG. 5 is a right side perspective view of a pet hydration system according to an embodiment of the invention, depicting the mounting clips on the exterior right side of the reservoir and showing the dispensing hose in a coiled position.

FIG. 6 is a left side bottom perspective view of a pet hydration system according to an embodiment of the invention, depicting the exterior of the case with the dispensing hose in an extended position.

FIG. 7 is a left side bottom perspective view of the reservoir assembly of a pet hydration system according to an embodiment of the invention, depicting the dispensing hose in an extended position.

FIG. 8 is a partially exploded left side bottom detail perspective view of the reservoir assembly of a pet hydration system according to an embodiment of the invention, depicting the reservoir fill cap in an open position and the dispensing hose detached from the hose attachment port.

FIG. 9 is a left side rear perspective view of a pet hydration system according to an embodiment of the invention, depicting the filling of the reservoir assembly partially removed from the case.

FIG. 10 is a perspective view of a pet hydration system according to an embodiment of the invention, depicting the pet hydration system attached to a dog's leash.

FIG. 11 is a perspective view of a pet hydration system according to an embodiment of the invention, depicting the use of the pet hydration system to provide drinking water to a dog.

### REFERENCE NUMBERS

10 Pet hydration system
100 Reservoir assembly
102 Reservoir
104 Hose attachment port
110 Fill port
112 Fill port cap
114 Fill port cap hinge
120 Reservoir flange
122 Eyelet
150 Dispensing hose
152 Hose connector
154 Valve Assembly
160 Nozzle
200 Case
202 Case opening
204 Hose passthrough
206 Pocket
210 Zipper
212 Zipper pull
220 Hose straps
230 Belt loops
232 Snaps
240 Support straps
242 D-ring
244 Carabiner
300 Leash
400 Tap

### DETAILED DESCRIPTION OF THE DRAWINGS

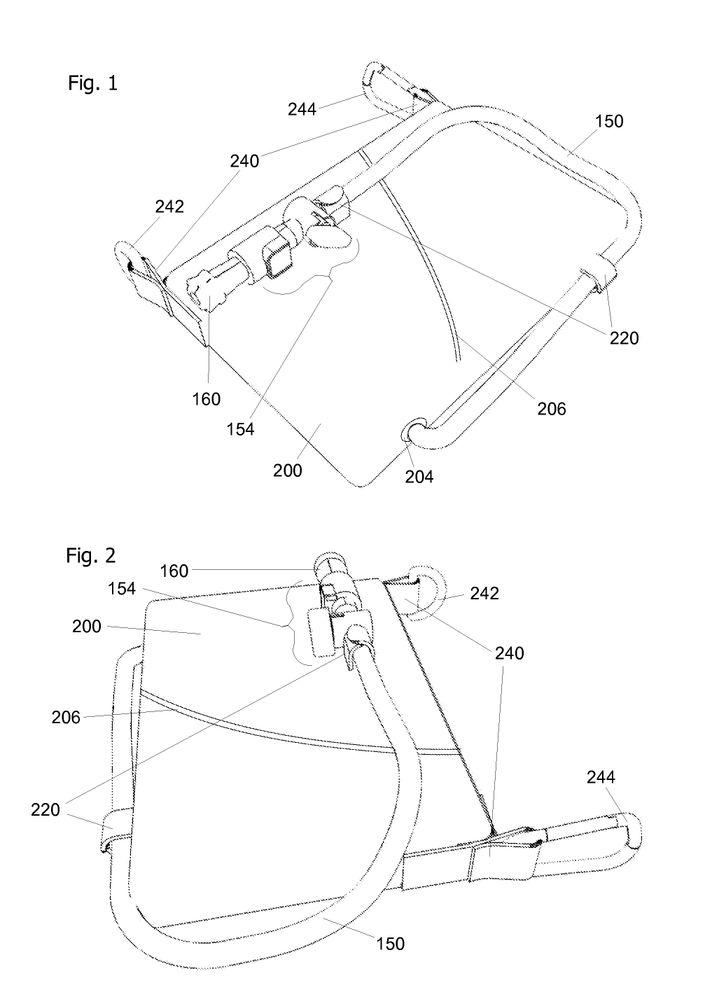

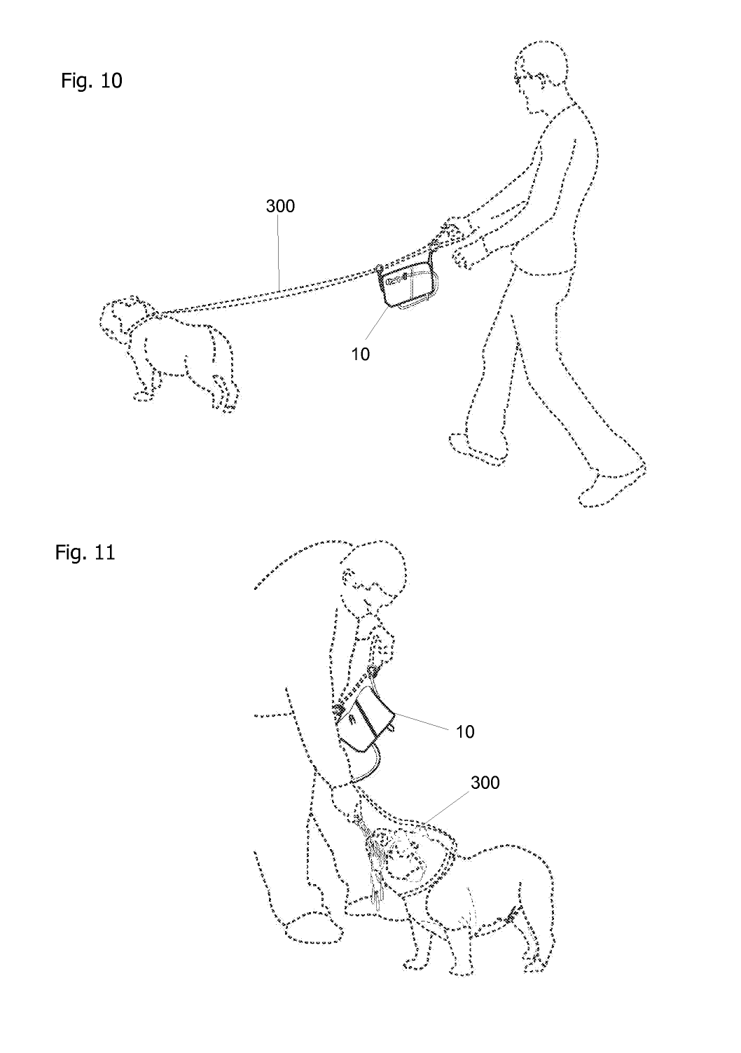

FIG. 1 is a left side front perspective view of a pet hydration system according to an embodiment of the invention, depicting the exterior of the case 200 with the dispensing hose 150 in a coiled position. When not in use, the dispensing hose 150 with its attached valve assembly 154 and nozzle 160 are secured to the case 200 with hose straps 220, which are preferably closed with hook and loop fasteners, allowing the pet hydration system to be transported in a compact form, while enabling the dispensing hose 150 to be readily deployed by simply opening the hose straps 220. One of the hose straps 220 is preferably located directly to the rear of the valve assembly 154 when the dispensing hose 150 is coiled on the side of the case 200, and the other located opposite to the hose passthrough 204 on the bottom of the case 200. The case 200 can be suspended from a pet's leash (as shown in FIGS. 10 and 11) by means of support straps 240. The front one of the support straps 240 is preferably equipped with a D-ring 242 through which the pet's leash can be threaded, and the rear one of the support straps 240 is preferably equipped with a carabiner 244 which can be clipped to the loop of the pet's leash handle. A pocket 206 or pockets may also be provided on the case 200 for convenient storage of small items, such as pet waste bags, pet treats, or keys.

FIG. 2 is a left side rear perspective view of a pet hydration system according to an embodiment of the invention, depicting the exterior of the case 200 with the dispensing hose 150 in a coiled position. The case 200, pocket 206, support straps 240, and hose straps 220 are preferably constructed of a durable fabric, such as nylon or neoprene, and the case 200 may be manufactured in a variety of colors and shapes, and decorated with imprinted graphics, embroidery, or other styling features or accents. The D-ring 242 and carabiner 244 may be constructed of any suitable hard material, such as metal, plastic, wood, or composites, and in a preferred embodiment are made of metal.

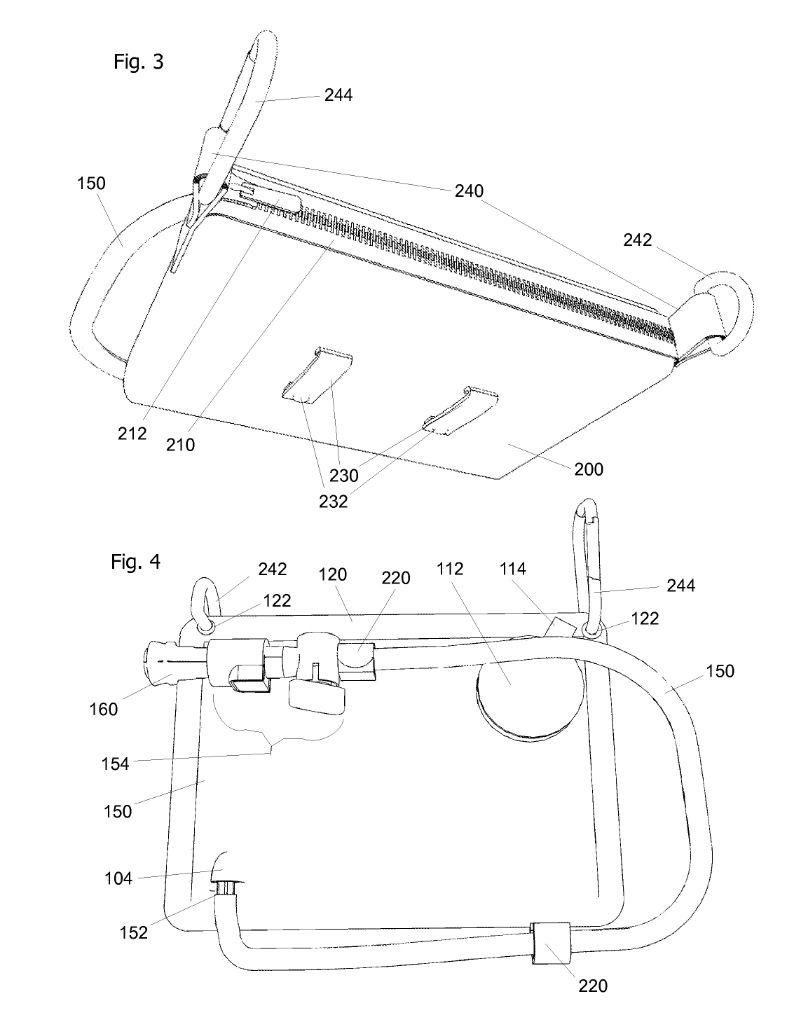

FIG. 3 is a right side top perspective view of a pet hydration system according to an embodiment of the invention, depicting belt loops 230 on the exterior right side of the case 200 and showing the dispensing hose 150 in a coiled position. Access to the interior of the case 200 is preferably through a case opening 202 in the top side, and in a preferred embodiment the case opening 202 is closed with a zipper 210, which may be opened and closed in the usual way with a zipper pull 212. As an alternative to, and in addition to the support straps 240, and the D-ring 242 and carabiner 244 which may be used to attach the pet hydration system to a pet's leash (as shown in FIGS. 10 and 11), the case 200 may include one or more belt loops 230, or belt clips, for attaching the case 200 to the user's clothing or belt. These belt loops 230 or belt clips may be secured with snaps 232 or other suitable fastening means, such as hook and loop fasteners, and may be constructed from any suitable rigid or flexible material, as desired, such as plastic, metal, or fabric. In a preferred embodiment, the belt loops 230 are rigid plastic clips, permitting attachment of the case 200 to the waistband of a user's pants without the need for a belt.

FIG. 4 is a left side perspective view of a pet hydration system according to an embodiment of the invention, depicting the exterior of the reservoir 102 with the dispensing hose 150 in a coiled position. As an alternative to a case (200, as shown in the preceding figures), the reservoir 102 itself may include flanges 120 containing eyelets 122 for mounting hardware such as a D-ring 242 through which the pet's leash can be threaded, and a carabiner 244 which can be clipped to the loop of the pet's leash handle. In such an embodiment, hose straps 220 can be provided on the exterior of the reservoir 102 allowing the pet hydration system to be transported in a compact form, while enabling the dispensing hose 150 to be readily deployed by simply opening the hose straps 220. The hose straps 220 are preferably closed with hook and loop fasteners. One of the hose straps 220 is preferably located directly to the rear of the valve assembly 154 when the dispensing hose 150 is coiled on the side of the reservoir 102, and the other located on the bottom of the reservoir 102 on the end opposite to the hose connector 152.

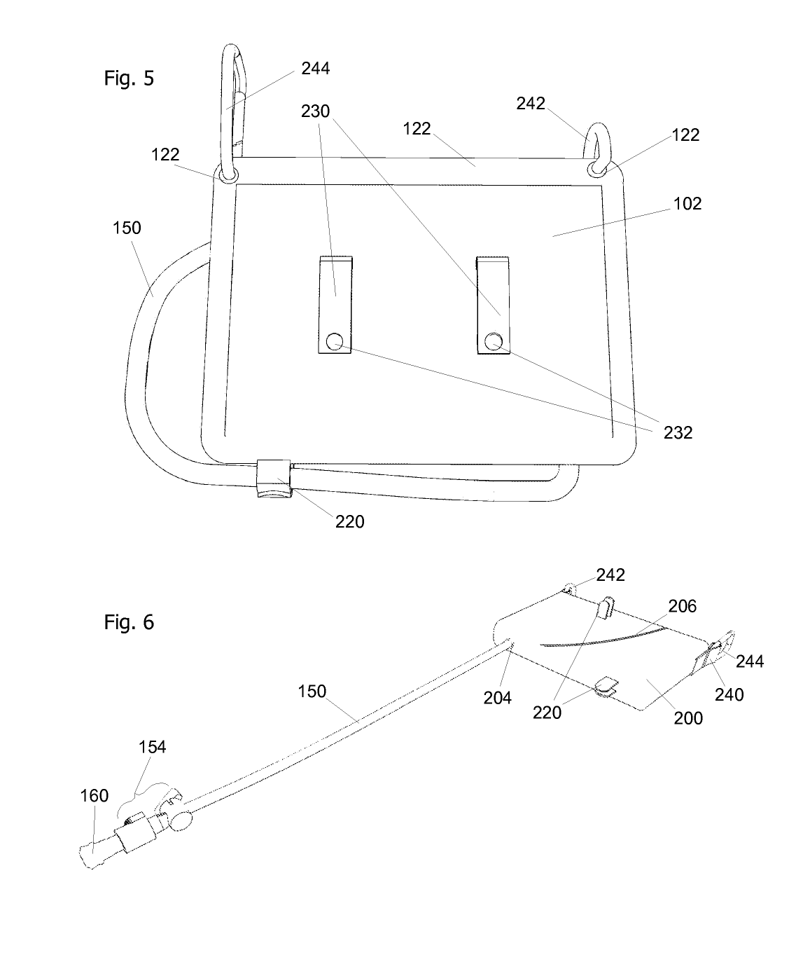

FIG. 5 is a right side perspective view of a pet hydration system according to an embodiment of the invention, depicting belt loops 230 on the exterior right side of the reservoir 102 and showing the dispensing hose 150 in a coiled position. These belt loops 230 or belt clips may be secured with snaps 232 or other suitable fastening means, such as hook and loop fasteners, and may be constructed from any suitable rigid or flexible material, as desired, such as plastic, metal, or fabric. In a preferred embodiment, the belt loops 230 are rigid plastic clips, permitting attachment of the reservoir 102 to the waistband of a user's pants without the need for a belt.

FIG. 6 is a left side bottom perspective view of a pet hydration system according to an embodiment of the invention, depicting the exterior of the case 200 with the dispensing hose 150 in an extended position. The dispensing hose 150 is deployed by opening the hose straps 220, and uncoiling the hose 150 with its attached valve assembly 154 and nozzle 160. The valve assembly can then be activated (as shown in FIG. 11) to dispense liquid from the reservoir (shown in next figure) which is located inside the case 200. When not in use, the dispensing hose 150, valve assembly 154 and nozzle 160 can be stowed in a coiled position (shown in FIGS. 1-3) by securing them to the case 200 with the hose straps 220.

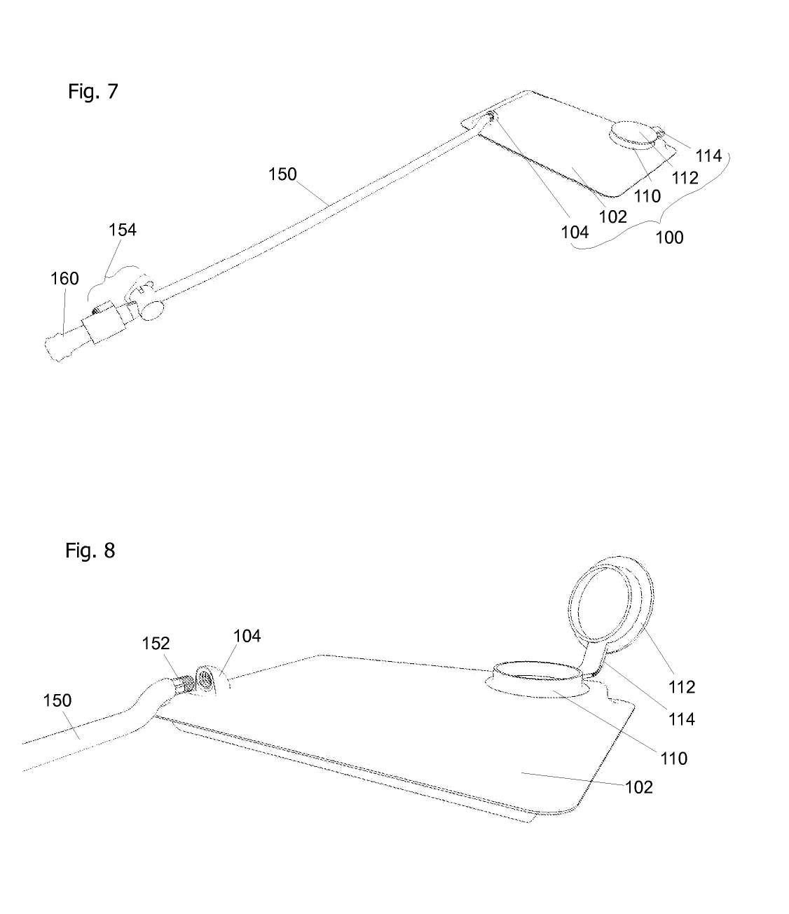

FIG. 7 is a left side bottom perspective view of the reservoir assembly 100 of a pet hydration system according to an embodiment of the invention, depicting the dispensing hose 150 in an extended position. This view corresponds to the view shown in the preceding figure, and shows the reservoir assembly 100 with attached dispensing hose 150 with the case (200, shown in FIGS. 1-3) removed. The reservoir assembly includes a reservoir 102 for holding liquid, a hose attachment port 104 to which the dispensing hose 150 is attached, and a fill port 110 equipped with a fill cap 112. In a preferred embodiment, the fill cap 112 is retained by a fill port hinge 114, which may be formed as a living hinge or tether connection between the fill port 110 and fill cap. Convenient dispensing of liquid from the reservoir 102 (as shown in FIG. 11) is accomplished by activation of the valve assembly 154 and nozzle 160 located on the end of the dispensing hose 150 opposite to the hose attachment port 104 on the reservoir 102. The dispensing hose 150 may be constructed from any suitable flexible material, such as rubber or plastic, and in a preferred embodiment is made of food grade bisphenol-A-free thermoplastic polyurethane. The valve assembly 154 may consist of one or more valves of any type suitable for regulating the flow of liquids, such as squeeze or bite valves, momentary push button valves, or plug or ball valves, and may be constructed from any suitable rigid or flexible material, as desired, depending upon the type of valve used, to include plastic, metal, silicone, rubber or composites. In a preferred embodiment, the valve assembly 154 can be combined with the nozzle 160 to reduce the cost and size of these components, and is formed of a food grade bisphenol-A-free plastic. Due to the nozzle 160 and valve assembly 154 typically being larger than the diameter of the dispensing hose 150, and thus unable to fit through the hose passthrough 204 (shown in the preceding figure), the dispensing hose 150 in a preferred embodiment is configured to be detachable from the reservoir 102 at the hose attachment point 104, so that the end of the dispensing hose 150 opposite to the valve assembly 154 and nozzle 160 can be inserted into the case 200 through the hose passthrough 204, and joined to the reservoir assembly 100 at the hose attachment point 104. The reservoir assembly 100 may be constructed from any suitable rigid or flexible material, such as plastic, silicone or rubber, and in a preferred embodiment is made of food grade bisphenol-A-free thermoplastic polyurethane.

FIG. 8 is a partially exploded left side bottom detail perspective view of the reservoir assembly of a pet hydration system according to an embodiment of the invention, depicting the fill port cap 112 in an open position and the dispensing hose 150 detached from the hose attachment port 104. The dispensing hose 150 is fitted with a hose connector 152 that is configured to be complementary to the hose attachment port 104 on the reservoir 102, engaging therewith to form a leak-resistant seal, and sized to be able to be inserted into the case 200 through the hose passthrough 204 (see FIGS. 1 and 4). In a preferred embodiment, the hose attachment port 104 and the hose connector 152 form a complementary compression-type threaded fitting. Once the dispensing hose 150 is securely attached to the hose attachment port 104 on the reservoir 102, and the valve assembly 154 configured to stop the flow of liquid through the nozzle 160 (see preceding figure), the reservoir 102 may be filled with the liquid to be dispensed.

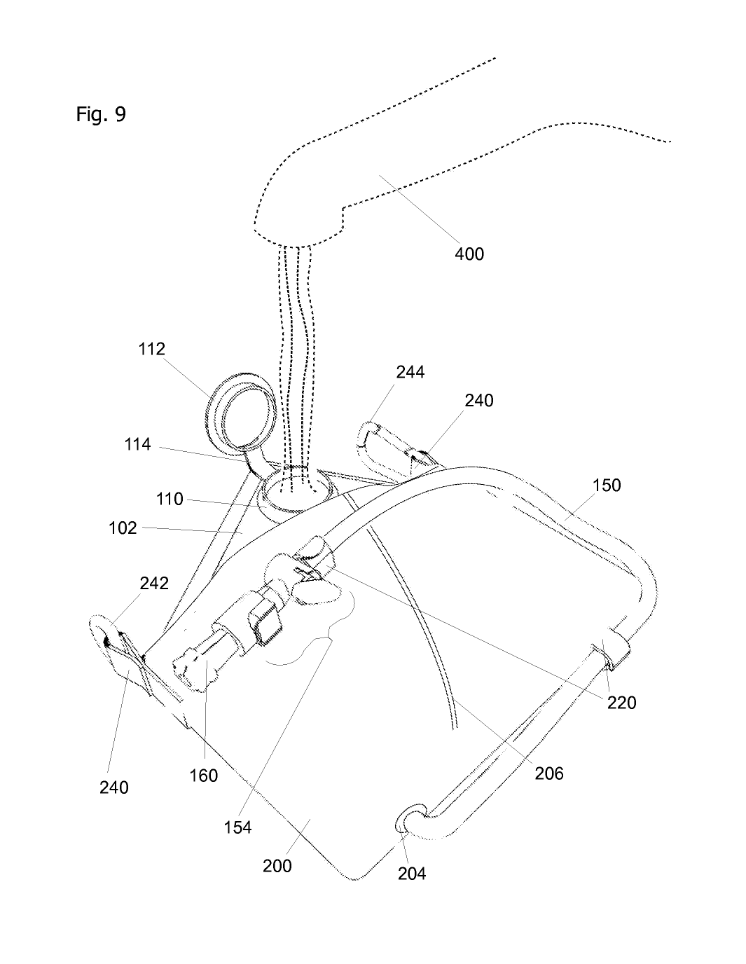

FIG. 9 is a left side rear perspective view of a pet hydration system according to an embodiment of the invention, depicting the filling of the reservoir assembly partially removed from the case. In a preferred embodiment, and as shown in the preceding figure, the fill port 110 is located at the upper corner of the reservoir 102 diagonally opposite to the hose attachment port 104, so that the upper corner of the reservoir 102 in which the fill port 110 is located can be accessed by rotating that corner of the reservoir 102 upwards through the case opening 202 (shown in FIG. 3), with the hose passthrough 204 and dispensing hose 150 serving as a pivot. If necessary or convenient, some slack for this rotation may be obtained by temporarily pushing part of the dispensing hose 150 into the case 200 through the hose passthrough 204. To fill the reservoir 102, the fill port cap 112 is opened as shown, and liquid is loaded into the reservoir 102 through the fill port 110 from a desired source, such as a tap 400. Once the liquid has been loaded, the fill port cap 112 is then replaced, sealing the fill port 110, and the reservoir assembly 100 may then be returned to its original position within the case 200. Filling the reservoir 102 of the pet hydration system according to the present invention does not require that the reservoir assembly 100 be completely removed from the case 200, or that the dispensing hose 150 be detached and reassembled.

FIG. 10 is a perspective view of a pet hydration system according to an embodiment of the invention, depicting the pet hydration system attached to a dog's leash. For convenience, the pet hydration system 10 according to the present invention may be clipped to a pet's leash 300 (as described above in connection with FIG. 1). This configuration provides ready access to the pet hydration system 10, without encumbering the pet with the weight of its own water supply.

FIG. 11 is a perspective view of a pet hydration system according to an embodiment of the invention, depicting the use of the pet hydration system to provide drinking water to a dog. When clipped to the pet's leash 300, the pet hydration system 10 can be supported by one hand, while the liquid is dispensed to the pet with the other (as described above in connection with FIG. 6).

We claim:

1. A portable pet hydration system comprising:
a case enclosing a reservoir configured for receiving a quantity of liquid;
said case comprising a reclosable case opening, a hose passthrough, and at least one leash attachment means;
said reservoir comprising a fill port and a hose attachment port;
a fill cap configured for reversibly sealing said fill port;
a dispensing hose having a first end and a second end, said first end comprising a hose connector configured to pass through said hose passthrough of said case and reversibly join to said hose attachment port of said reservoir, and said second end comprising a valve assembly configured for controlling the dispensing of liquid from said reservoir by means of said dispensing hose, said valve assembly comprising a nozzle configured for dispensing liquid.

2. The pet hydration system of claim 1, wherein the case further comprises at least one hose strap configured for reversibly securing the dispensing hose to the case.

3. The pet hydration system of claim 1, wherein the at least one leash attachment means comprises a clipping means.

4. The pet hydration system of claim 3, wherein the at least one leash attachment means further comprises an annulus configured for threading a leash through.

5. The pet hydration system of claim 4, wherein the clipping means is a carabiner and the annulus configured for threading a leash through is a D-ring.

6. The pet hydration system of claim 2, wherein the at least one leash attachment means comprises a clipping means.

7. The pet hydration system of claim 6, wherein the at least one leash attachment means further comprises an annulus configured for threading a leash through.

8. The pet hydration system of claim 7, wherein the clipping means is a carabiner and the annulus configured for threading a leash through is a D-ring.

9. The pet hydration system of claim 1, wherein the case further comprises a means for reversibly attaching the case to a user's clothing.

10. The pet hydration system of claim 8, wherein the case further comprises a means for reversibly attaching the case to a user's clothing.

11. A portable pet hydration system comprising:
a reservoir configured for receiving a quantity of liquid, said reservoir comprising a fill port, a hose attachment port, and at least one leash attachment means;
a fill cap configured for reversibly sealing said fill port;
a dispensing hose having a first end and a second end, said first end comprising a hose connector configured to reversibly join to said hose attachment port, and said second end comprising a valve assembly configured for controlling the dispensing of liquid from said reservoir by means of said dispensing hose, said valve assembly comprising a nozzle configured for dispensing liquid.

12. The pet hydration system of claim 11, wherein the reservoir further comprises at least one hose strap configured for reversibly securing the dispensing hose to the reservoir.

13. The pet hydration system of claim 11, wherein the at least one leash attachment means comprises a clipping means.

14. The pet hydration system of claim 13, wherein the at least one leash attachment means further comprises an annulus configured for threading a leash through.

15. The pet hydration system of claim 14, wherein the clipping means is a carabiner and the annulus configured for threading a leash through is a D-ring.

16. The pet hydration system of claim 12, wherein the at least one leash attachment means comprises a clipping means.

17. The pet hydration system of claim 16, wherein the at least one leash attachment means further comprises an annulus configured for threading a leash through.

18. The pet hydration system of claim 17, wherein the clipping means is a carabiner and the annulus configured for threading a leash through is a D-ring.

19. The pet hydration system of claim 11, wherein the reservoir further comprises a means for reversibly attaching the reservoir to a user's clothing.

20. The pet hydration system of claim 18, wherein the reservoir further comprises a means for reversibly attaching the reservoir to a user's clothing.
